(19) United States
(12) Patent Application Publication
(10) Pub. No.: US 2005/0186524 A1
(43) Pub. Date: Aug. 25, 2005

(54) Arch expander

(75) Inventors: Amir Abolfathi, Woodside, CA (US); Peter G. Knopp, Palo Alto, CA (US)

Correspondence Address: ALIGN TECHNOLOGY, INC.;ATTENTION: SCOTT SMITH, 881 MARTIN AVENUE, SANTA CLARA, CA, 95050, US

(73) Assignee: ALIGN TECHNOLOGY, INC., Santa Clara, CA (US)

(21) Appl. No.: 10/786,759

(22) Filed: Feb. 24, 2004

(51) Int. Cl. A61C 3/00

(52) U.S. Cl. 433/7; 433/6

(57) ABSTRACT

Systems and methods are disclosed for making an arch expander for a patient by scanning the patient's dentition; fabricating an appliance adapted to be positioned between posterior teeth and a palatal arch, the appliance having first and second movable portions; and providing an expander between the first and second portions of the appliance.

### BACKGROUND

The present invention relates to arch expanders.

The dental specialty orthodontics is concerned with the correction of alignment and positional abnormalities of the teeth. It is not uncommon for patients receiving such treatment to require a regimen which continues over many months and involves the use of various appliances affixed within the mouth to achieve repositioning of displaced teeth. The repositioning is accomplished, generally, by attachment of an orthodontic appliance to one or several of the teeth in order to provide forces on the affected teeth which accomplish the desired repositioning. The appliance may be a fixed appliance with wire and brackets, or may be a removable appliance such as the Invisalign® system from Align Technology, Inc. of Santa Clara, Calif.

As discussed in U.S. Pat. No. 5,399,087, often it is necessary for the orthodontic clinician to reposition a patient's maxillary and mandibular first permanent molars by de-rotating the molars or expanding the distance between the molars. This procedure, in the case of maxillary first permanent molars, is often accomplished during the course of generally expanding the palate to properly position the molars and reduce crowding of the upper arch interior teeth as well as to adjust the occlusion and bite.

To achieve this expansion of the molars and the palatal arch it has been common practice to utilize various types of arch bars or jack screws which are positioned between the maxillary molars to achieve rotation of the molars and to accomplish the desired expansion of the palate. Typically these types of devices require a number of weeks or months of action on the teeth to accomplish the desired goal. In the case of stainless steel type arch wires the orthodontic appliance operates by simple mechanical pressure against the lingual side of the molars. The stainless steel appliance's ability to expand the palate is limited to the steel's capacity to withstand compression before reaching its yield point. This limitation of stainless steel requires periodic return visits to the orthodontist so the appliance can be reformed.

### SUMMARY OF THE INVENTION

In one aspect, a method for making an arch expander for a patient includes scanning the patient's dentition; fabricating an appliance adapted to be positioned between posterior teeth and a palatal arch, the appliance having first and second movable portions; and providing an expander between the first and second portions of the appliance.

Implementations of the above aspect may include one or more of the following. The expander may be adjusted to vary the spacing between the first and second portions of the appliance. The expander can be one or more screws or one or more springs. The first and second portions can be super-elastic nitinol. The appliance can be fabricated using a stereolithography apparatus (SLA). The scanning can include intra-oral scanning. Alternatively, the scanning can include taking an impression of the patient's teeth; placing the impression in a scanner; and generating a 3D model of the impression. The scanning captures the patients' dentition and palatal arch. The process includes adjusting the expander on a periodic basis.

In another aspect, a dental appliance includes a shell including at least one layer of a polymeric material and having a cavity which fits closely over one or more posterior teeth, the shell having first and second moveable portions; and an expander positioned between the first and second portions of the appliance. Implementations of the above aspect may include one or more of the following. The expander is user-adjustable to vary spacing between the first and second portions of the appliance. The expander can be one or more screws or springs.

### BRIEF DESCRIPTION OF THE DRAWINGS

FIG. 1 shows an exemplary process to fabricate an arch expander.

FIG. 2 shows a first embodiment of an arch expander.

FIG. 3 shows a second embodiment of an arch expander.

FIG. 4 shows a third embodiment of an arch expander.

### DESCRIPTION

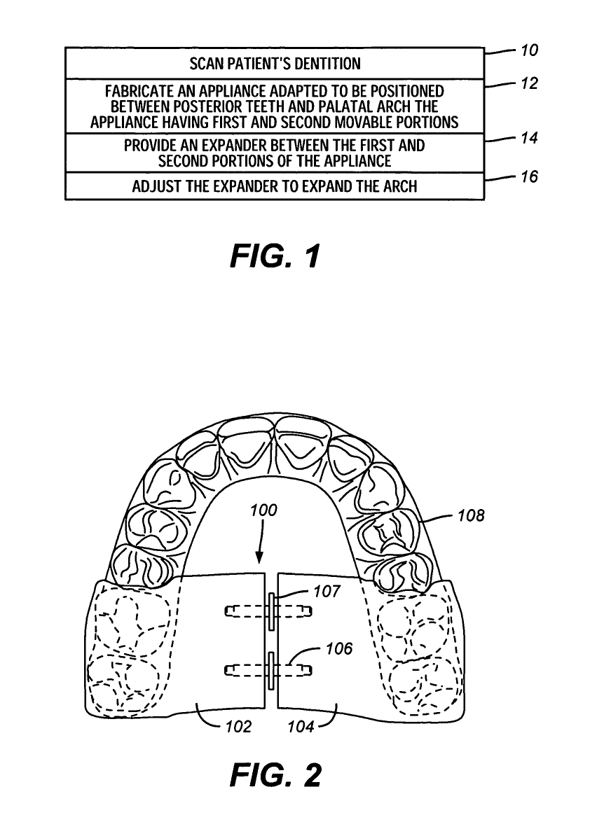

FIG. 1 shows an exemplary process to fabricate an arch expander. The process scans patient's dentition (10). The scan covers the patient's dentition and palatal arch. The information is digitized and a 3D model is generated in a computer's data storage. Next, the process fabricates an appliance adapted to be positioned between posterior teeth and a palatal arch the appliance having first and second movable portions (12). The process then inserts an expander between the first and second portions of the appliance (14). The expander may include springs or screws that enable the first and second portions to be expanded or contracted, respectively. Next, the appliance is mounted on the patient. Periodically, a treatment professional adjusts the expander to expand the arch (16).

Because a patient's teeth may respond differently than originally expected, the treating clinician may wish to evaluate the patient's progress during the course of treatment. If the patient's arch does not progress as planned, the clinician can revise the treatment plan as necessary to bring the patient's treatment back on course or to design an alternative treatment plan.

FIG. 2 shows an exemplary arch expander appliance 100 that is removably replaceable over the patient's teeth. Usually, appliance 100 effects incremental expansion of individual teeth in the jaw. The exemplary appliance 100 includes a polymeric shell 102 having an inner cavity 120, a proximal edge 116, and a distal edge 118. Cavity 120 is shaped to receive and resiliently reposition teeth from one tooth arrangement to a successive tooth arrangement. The polymeric shell will preferably, but not necessarily, fit over the posterior teeth present in the upper or lower jaw 114. Often, only certain posterior teeth will be repositioned while others of the teeth will provide a base or anchor region for holding the repositioning appliance in place as it applies the resilient repositioning force against the tooth or teeth to be repositioned. The gums and/or the palette can also serve as an anchor region, thus allowing all or nearly all of the teeth to be repositioned simultaneously. Additionally, anchors and adhesives, which are described in more detail below, are available which may also serve as attachment points for appliance 100.

The shell 102 has two moveable portions 103 and 105. In one embodiment, shell portions 103 and 105 are held or anchored to the each other through an expander 124. The expander 124 may be a screw, spring, or any adjustable device that increases or decreases the separation of the portions 103 and 105.

Once shell 102 is in position e.g. engaged with the posterior teeth, the shell provides the desired repositioning forces to the teeth. At such time as desired, shell 102 may then be expanded by adjusting the screw or spring. The shell 102 may also be contracted to allow for easy removal of appliance 100.

When worn by the user, the shell 102 is forced down over teeth, typically by the patient biting down on the shell or by other forms of manual pressure being applied to the shell. Edges 116 and 118 are made to engage the posterior teeth.

The appliance 100 provides the type of pressure to the palatal arch which is believed ideal. This pressure is a constant pressure which is of a soft and uniform nature which results in expansion of the teeth and palatal arch generally while allowing incremental separation of the palatal suture thereby permitting proper bone plating. The pressure on the teeth can be adjusted by a treating professional to deliver a low force, and the expander 124 provides a uniform linear force decay over time as the palatal arch is expanded. Such uniform decay of low pressure forces is considered more desirable for physiologic bone response.

Shell 102 is made of a material that has a predetermined modulus, also referred to as the stiffness, of the material. Generally, the modulus is a measurement of the inherent stiffness of a material determined by conducting stress and strain tests on a material specimen and plotting the results. The value of the slope of the line generated by the results is the modulus. The modulus can be predetermined to match the compliance required to reposition the teeth based on requirements set by an individual patient's repositioning needs. In one example, the shell may have a modulus in the range of between about 0.1 GPa to 4 GPa, usually 0.5 GPa to 3 GPa, preferably about 0.8 GPa to 1.5 GPa.

Often, the shell is formed from a material that has uniform properties, particularly stiffness, over the entire area. In some cases, however, it will be desirable to vary the stiffness, thickness, or other material properties of the shell at different points or segments. Also, other layers, reinforcement elements, holes, or components may be added to the shell to vary its stiffness and/or other mechanical properties.

Shell 102 may also be configured with a reinforcement structure, such as a wire, a filament, a mesh, a ring, and/or a braid. The reinforcement structure may also be of undergoing a change in material property or else a change in shape, such that the change facilitates the removal of the appliance from the teeth. For example, appliance 100 may be fabricated with a polymeric external layer and a metal inner wire embedded in at least a portion of the appliance proximate to either the engagement with the undercut or the engagement with the anchor. The metal inner wire can be made of a memory shape metal, such as Nitinol, Bimetal, Memotal or similar alloy. The wire undergoes a change in material property (and/or shape) as it is subjected to a thermal stimulus or other external stimulus. In this example, the wire changes geometry. Since the wire is embedded within the appliance, the appliance also changes shape, which expands or contracts the teeth on the arch.

In general, once the patient requests treatment, the treating professional takes impressions and a bite registration and sends the information to an appliance provider such as Align Technology, Inc. The treating professional may also capture other data, such as by taking a lateral ceph and a panorex, and upload them to the company and/or workspace and/or website. The treating professional may also generate or create a treating prescription or plan and upload the same to the company and/or website and/or to the workspace. At any time, the treating professional may review the treatment plan and adjust or approve the same. The professional can also invite a consultant such as an orthodontist to review the images. Once a treatment plan is accepted, appliances such as aligners may then be accordingly fabricated as described below.

At a fabrication company such as Align Technology, Inc., a technician reviews the records and decides to accept or decline the case. If accepted, the models are scanned, and the intraoral images are retrieved. In one embodiment, the tooth models may be posted on a hypertext transfer protocol (http) web site for limited access by the corresponding patients and treating clinicians. Since realistic models have a large volume of data, the storage and transmission of the models can be expensive and time-consuming. To reduce transmission problems arising from the large size of the 3D model, in one embodiment, data associated with the model is compressed. The compression is done by modeling the teeth meshes as a curve network before transmission to the treating professional or website. Once the curve network is received, the 3D model is reconstructed from the curve network for the treating professional to analyze. More information on the compression is disclosed in a co-pending application having Ser. No. 09/506,419, entitled, “EFFICIENT DATA REPRESENTATION OF TEETH MODEL”, and filed by ELENA PAVLOVSKAIA and HUAFENG WEN on Feb. 17, 2000, the contents of which are hereby incorporated by reference in their entirety.

The treating professional can, at his or her convenience, check the setup, and review the information. The treating professionals can use a variety of tools to interpret patient information. For example, the treating professional can retrieve and analyze patient information through a reconstructed 3D model of the patient's teeth and other anatomical structures. The professional can view animations showing the progress of the arch expansion to help the treating physician visualize the pace of treatment. Using these tools, the treating professional can easily and quickly view and/or edit the treatment plan.

If necessary, the treating professional can adjust one or more teeth positions at various intermediate stages of expansion. A variety of diagnostic decision-support capabilities such as automated teeth collision detection can be used to aid the treating professional in adjusting the teeth positions.

When the treating professional arrives at a prescription or other final designation, the treatment information is automatically collected by the system over the Internet, thus eliminating the cost and delay associated with the traditional physical shipping of patient information. These modifications are then retrofitted onto the dataset used to generate the arch expansion appliance which is then physically fabricated.

Once the data sets have been created, the appliances may be fabricated. Common fabrication methods employ a rapid prototyping device such as a stereolithography machine. A particularly suitable rapid prototyping machine is Model SLA-250/50 available from 3D Systems, Valencia, Calif. The rapid prototyping machine selectively hardens a liquid or other non-hardened resin into a three-dimensional structure which can be separated from the remaining non-hardened resin, washed, and used either directly as the appliance or indirectly as a mold for producing the appliance. The prototyping machine receives the individual digital data sets and produces one structure corresponding to each of the desired appliances. Generally, because the rapid prototyping machine may utilize a resin having non-optimum mechanical properties and which may not be generally acceptable for patient use, the prototyping machine typically is used to produce molds which are, in effect, positive tooth models of each successive stage of the treatment. After the positive models are prepared, a conventional pressure or vacuum molding machine is used to produce the appliances from a more suitable material, such as 0.03 inch thermal forming dental material, available from Tru-Tain Plastics, Rochester, Minn. Suitable pressure molding equipment is available under the trade name BIOSTAR from Great Lakes Orthodontics, Ltd., Tonawanda, N.Y. The molding machine produces each of the appliances directly from the positive tooth model and the desired material. Suitable vacuum molding machines are available from Raintree Essix, Inc. In addition to fabricating the appliance using in part stereolithography, the appliance can also be manufactured using fused deposition modeling, or selective laser sintering

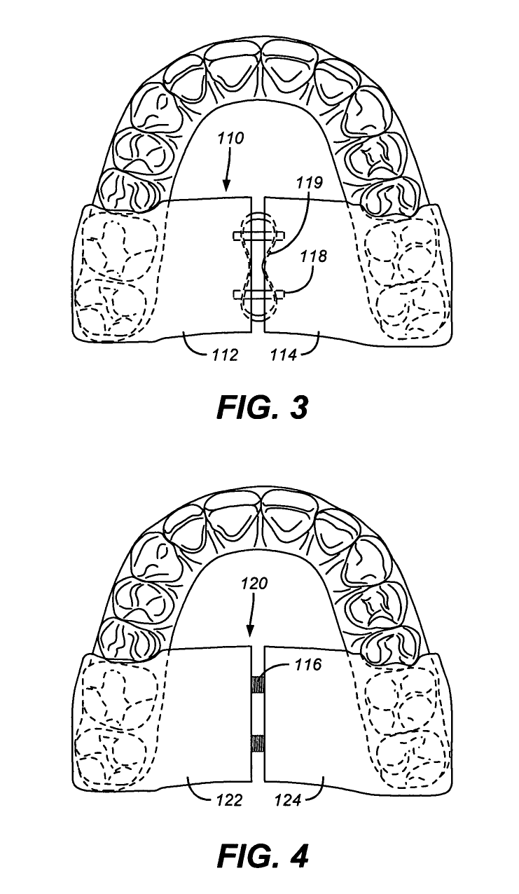

FIG. 2 shows a first embodiment of an arch expander 100. The appliance has two movable portions 102-104. In one embodiment, the portions 102-104 are made from thermoplastic. One or more expanders 106 are used to attach the portions together. The expanders 106 allow the portions to be spaced a predetermined distance from each other for expansion of the teeth. Alternatively, the expanders 106 can also reduce the spacing of the portions when the appliance is to be removed. In this embodiment, the expanders 106 are adjustable screw type expanders with dials 107 that can be rotated by a thumb or other suitable instruments to vary the separation of portions 102-104. FIG. 3 shows a second embodiment of an arch expander 110 that uses an elastic band 119 and holders 118 to vary the separation between portions 112-114. FIG. 4 shows a third embodiment of an arch expander 120. In this embodiment, one or more springs 116 are positioned between portions 122-124. The spring constant for each spring can be adjusted to vary the separation between portions 122-124.

At the base of the portions 102-104, 112-114 and 122-124, a plurality of cavities are formed with geometries shaped to receive the patient's posterior teeth and to secure the portions to the patient. To produce appliances that fit over the posterior teeth, the scanned patient data is used to define the geometry of the appliance using stereolithography, among others. In addition, it may be necessary to add other features to the data sets in order to produce desired features in the treatment appliances. For example, it may be desirable to add wax patches to the image in order to define cavities or recesses for particular purposes. For example, it may be desirable to maintain a space between the appliance and particular regions of the teeth or jaw in order to reduce soreness of the gums, avoid periodontal problems, allow for a cap, and the like. Additionally, it will often be necessary to provide a receptacle or aperture intended to accommodate an anchor which is to be placed on a tooth in order to permit the tooth to be manipulated in a manner that requires the anchor, e.g. lifted relative to the jaw. Some methods for manufacturing the tooth repositioning appliances require that the separate, repositioned teeth and other components be unified into a single continuous structure in order to permit manufacturing. In these instances, “wax patches” are used to attach otherwise disconnected components of the scanned data. These patches are added to the data set underneath the teeth and above the gum so that they do not effect the geometry of the tooth repositioning appliances. In this embodiment, a computer provides for a variety of wax patches to be added to the model, including boxes and spheres with adjustable dimensions. The wax patches that are added are treated by the software as additional pieces of geometry, identical to all other geometries. Thus, the wax patches can be repositioned during the treatment path as well as the teeth and other components.

An adhesive may be used to add holding strength between the expanders and the two portions of the appliance 100. The adhesive may have a peel strength that may be reduced or eliminated in order to remove the shell. For example, in its initial state the adhesive should have a peel strength of no less than about 250 g/cm, however, to remove the shell, the peel strength is reduced to a value below the 250 g/cm threshold. Adhesives, with compositions that are side chain crystalizable based polymer such as polyethylacrylate-hexadecylacrylate copolymer with XAMA 2, polypentadecylacrylate with cross linker, polyoctadecylacrylate with XAMA 2, and the like, may be used for such purposes.

Although the above process fabricates the appliance from a positive mold, the appliance can also be directly fabricated by the SLA machine.

The invention has been described in terms of particular embodiments. Other embodiments are within the scope of the following claims. It is to be understood that while a certain form of the invention has been illustrated and described, it is not limited thereto, except insofar as such limitations are included in the following claims and the allowable functional equivalents thereof.

1. A method for making a custom-fit palatal arch expander for a patient, the method comprising:
acquiring at least one digital scan representing at least a portion of upper teeth and a palate of the patient;
fabricating a first portion of the custom-fit palatal arch expander the first portion having a plurality of cavities for receiving posterior teeth on one side of the palate and a palatal portion extending toward a centerline of the palate;
fabricating a second portion of the arch expander the second portion having a plurality of cavities for receiving posterior teeth on an opposite side of the palate and a palatal portion extending toward the centerline of the palate; and
coupling an expansion member between the first and second portions,
wherein each of the plurality of cavities is specifically configured to fit over one of the posterior teeth of the patient based on the shapes of the posterior teeth as represented in the digital scan(s).

2. The method of claim 1, further comprising adjusting the expansion member to vary the spacing between the first and second portions.

3. The method of claim 1, wherein the expansion member comprises one or more screws.

4. The method of claim 1, wherein the expansion member comprises one or more springs.

5. The method of claim 1, wherein the first and second portions comprise super-elastic nitinol.

6. The method of claim 1, wherein the first and second portions are fabricated using stereolithography, fused deposition modeling, 3-D printing, or selective laser sintering.

7. The method of claim 1, wherein acquiring the at least one scan comprises intra-oral scanning.

8. The method of claim 1, wherein acquiring the at least one scan comprises:
taking an impression of the patient's teeth;
placing the impression in a scanner; and
generating a 3D model of the impression.

9-10. (canceled)

11. A custom-fit dental appliance for expanding a palatal arch of a patient, the appliance comprising:
a first portion having a plurality of cavities for receiving posterior teeth on one side of the patient's palate and a palatal portion extending toward a centerline of the palate;
a second portion having a plurality of cavities for receiving posterior teeth on an opposite side of the patient's palate and a palatal portion extending toward the centerline of the palate, wherein the first and second portions each include at least one layer of a polymeric material; and
an expander coupled between the first and second portions,
wherein each of the plurality of cavities is specifically configured to fit over one of the posterior teeth of the patient based on the shapes of the posterior teeth as represented in at least one digital scan(s) of at least some of the patient's teeth and the patient's palate.

12. The dental appliance of claim 11, wherein the expander is user-adjustable to vary a spacing between the first and second portions of the appliance.

13. The dental appliance of claim 11, wherein the expander comprises one or more screws.

14. The dental appliance of claim 11, wherein the expander comprises one or more springs.

15. The dental appliance of claim 11, wherein the first and second portions comprise super-elastic nitinol.

16. The dental appliance of claim 11, wherein the first and second portions are fabricated using stereo-lithography, fused deposition modeling, or selective laser sintering.

17. The dental appliance of claim 11, wherein the shape of each cavity of the first and second portions is determined by intra-orally scanning a patient.

18. The dental appliance of claim 11, wherein the shape of each cavity of the first and second portions is determined from digitally captured scans of a patient's dentition and palatal arch.

19. (canceled)

20. The dental appliance of claim 11, wherein the plurality of cavities are configured to allow the patient to remove and replace the dental appliance.

21. The dental appliance of claim 11, wherein the plurality of cavities are configured to retain the dental appliance without requiring brackets or other fixtures to be adhered to the patient's teeth.

22. A method for expanding a palatal arch of a patient, the method comprising:
acquiring at least one digital scan representing at least a portion of upper teeth and a palate of the patient;
fabricating, based on the scan(s), a custom-fit arch expander for the patient, the arch expander comprising:
a first portion having a plurality of cavities for receiving posterior teeth on one side of the palate and a palatal portion extending toward a centerline of the palate;
a second portion having a plurality of cavities for receiving posterior teeth on an opposite side of the palate and a palatal portion extending toward the centerline of the palate; and
coupling an expansion member between the first and second portions, wherein each of the plurality of cavities is specifically configured to fit over one of the posterior teeth of the patient, based on the shapes of the posterior teeth as represented in the digital scan(s); and
placing the arch expanded in the patient's mouth to expand the patient's palatal arch.
